(19) United States
(12) Patent Application Publication
(10) Pub. No.: US 2023/0025848 A1
(43) Pub. Date: Jan. 26, 2023

(54) SIMULATING WEATHER SCENARIOS AND PREDICTIONS OF EXTREME WEATHER

(71) Applicant: INTERNATIONAL BUSINESS MACHINES CORPORATION, Armonk, NY (US)

(72) Inventors: Dario Augusto Borges Oliveira, Sao Paulo (BR); Bianca Zadrozny, Rio de Janeiro (BR); Campbell D. Watson, Brooklyn, NY (US); Jorge Luis Guevara Diaz, Sao Paulo (BR)

(21) Appl. No.: 17/383,387

(22) Filed: Jul. 22, 2021

(51) Int. Cl. G01W 1/10; G06N 20/00; G06N 5/04; G06N 5/02; G06F 17/18

(52) U.S. Cl. CPC G01W 1/10; G06N 20/00; G06N 5/04; G06N 5/02; G06F 17/18

(57) ABSTRACT

A computer implemented method of predictive weather occurrences includes generating, by a computer processor, a training model through artificial intelligence. The training model is based on climate data processed by a variational autoencoder. A geographic location is selected for climate study. Historical weather measurements associated with the selected geographic location are retrieved from a knowledge climate database. The retrieved historical weather measurements are processed using the training model. The training model receives threshold parameters defining extremeness of weather. Extremeness is based on a weather intensity data point being farther from a norm than closer to the norm. Synthetic weather data is generated for the selected location, wherein the synthetic weather data predicts weather events satisfying the extremeness threshold parameters.

### BACKGROUND

### Technical Field

The present disclosure generally relates to meteorology, and more particularly, to a system and method for simulating weather scenarios and predictions of extreme weather.

### Description of the Related Art

Extreme climate events impact different activities and communities, causing substantial economic losses every year. Global warming and climate change make such events more common, and various risk and resilience models need to cope with that to deliver trustful responses accordingly. In some approaches, models receive as input among different variables, climate data. In this context, the ability to create realistic synthetic weather data for various scenarios is of high value to actors working with risk and resilience models for climate events. However, conventional methods generally focus on typical or highly probably weather events. Extreme weather event prediction is often ignored. Current methods require contextual information on climate at the location, or exploratory analysis of the data to infer characteristics.

Weather generators are one mechanism that usually use historical weather data to extrapolate future climate data from those previously observed. These tools struggle to synthesize data with complex trends since they learn to synthesize data with a probability observed in history.

As the climate system warms, the frequency, duration, and intensity of different types of extreme weather events have been increasing. For example, climate change leads to more evaporation that may exacerbate droughts and increase the frequency of heavy rainfall and snowfall events. That directly impacts various sectors such as agriculture, water management, energy, and logistics, which traditionally rely on seasonal forecasts of climate conditions for planning their operations.

In this context, weather generators are often used to provide a set of plausible climatic scenarios, which are then fed into impact models for resilience planning and risk mitigation. A variety of weather generation techniques have been developed over the last decades. However, they are often unable to generate realistic extreme weather scenarios, including severe rainfall, windstorms, and droughts.

Recently different approaches proposed to explore deep generative models in the context of weather generation, and most explored generative adversarial networks (GAN) to learn single-site precipitation patterns from different locations. One approach proposes a GAN-based approach to generate realistic extreme precipitation samples using extreme value theory for modeling the extreme tails of distributions. Another approach reconstructs the missing information in passive microwave precipitation data with conditional information. Yet another proposed approach includes a GAN-based technique for generating spatiotemporal weather patterns conditioned on detected extreme events.

While GANs are very popular for synthesis in different applications, they do not explicitly learn the training data distribution and therefore depend on auxiliary variables for conditioning and controlling the synthesis.

### SUMMARY

According to an embodiment of the present disclosure, a computer implemented method for predictive weather occurrences is provided. The method includes generating, by a computer processor, a training model through artificial intelligence. The training model may be based on climate data processed by a variational autoencoder. A geographic location is selected for climate study. Historical weather measurements associated with the selected geographic location are retrieved from a knowledge climate database. The retrieved historical weather measurements are processed using the training model. The training model may receive threshold parameters defining extremeness of weather. Extremeness is based on a weather intensity data point being farther from a distribution mean than closer to the distribution mean. Synthetic weather data is generated for the selected location predicting weather events satisfying the extremeness threshold parameters.

In one embodiment, the generated synthetic weather data is based on a stochastic distribution of the retrieved historical weather measurements. By using stochastic synthesis, regularizing the latent space to a known distribution becomes easier and the extreme data points are more readily identifiable.

According to an embodiment of the present disclosure, a computer program product for predictive weather occurrences is provided. The computer program product includes one or more computer readable storage media, and program instructions collectively stored on the one or more computer readable storage media. The program instructions include generating a training model through artificial intelligence. The training model may be based on climate data processed by a variational autoencoder. A geographic location is selected for climate study. Historical weather measurements associated with the selected geographic location are retrieved from a knowledge climate database. The retrieved historical weather measurements are processed using the training model. The training model receives threshold parameters defining extremeness of weather. Extremeness is based on a weather intensity data point being farther from a distribution mean than closer to the distribution mean. Synthetic weather data is generated for the selected location predicting weather events satisfying the extremeness threshold parameters.

According to one embodiment, the program instructions further include weather events satisfying the extremeness threshold parameters that are based on a rarity of occurrence in the training model. As will be appreciated, the accuracy of the training model is improved by correlating extreme weather events with rarity since in many locations, the frequency of extreme weather is generally more rare than average weather phenomena.

According to an embodiment of the present disclosure, a computer server includes: a network connection; one or more computer readable storage media; a processor coupled to the network connection and coupled to the one or more computer readable storage media; and a computer program product including program instructions collectively stored on the one or more computer readable storage media. The program instructions include generating, by the computer processor, a training model through artificial intelligence. The training model is based on climate data processed by a variational autoencoder. A geographic location is selected for climate study. Historical weather measurements associated with the selected geographic location are retrieved from a knowledge climate database. The retrieved historical weather measurements are processed using the training model. The training model may receive threshold parameters defining extremeness of weather. Extremeness is based on a weather intensity data point being farther from a distribution mean than closer to the distribution mean. Synthetic weather data is generated for the selected location predicting weather events satisfying the extremeness threshold parameters.

According to one embodiment, the program instructions for the computer server further include: receiving a likelihood value for the threshold parameters. The likelihood value represents a probability of a weather data point satisfying the extremeness threshold parameters. The processed retrieved historical weather measurements are distributed into a normalized distribution. In addition, weather data points satisfying the extremeness threshold parameters are identified based on the likelihood value.

As may be appreciated, aspects of the subject technology may train a neural network model to identify which weather events occur less frequently than other measurable events. A correlation between frequency of a weather data point and its extremeness can be provided to the model making it easier for the model to understand weather extremeness and predict the likelihood of an extreme event occurring for a location.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of an architecture for generating extreme weather event prediction according to an embodiment.

FIG. 2 is a flowchart of a method for synthesizing extreme weather data according to some embodiments.

FIG. 3 is a block diagram of variational autoencoder (VAE) network for training weather data according to an embodiment.

FIG. 4 is a block diagram of a schema architecture for predicting extreme weather data according to an embodiment.

FIGS. 5A and 5B are plots of weather event type frequency according to embodiments.

FIG. 6 is a diagrammatic view of a proposed sampler schema according to an embodiment.

FIG. 7 is a diagrammatic view of a sampler distribution result according to embodiments.

FIG. 8 is a plot showing a relationship between weather intensity and appearance of frequency according to embodiments.

FIG. 9 is a flowchart of a method of synthesizing weather data for the prediction of extreme weather events according to an embodiment.

FIG. 10 is a functional block diagram illustration of a computer hardware platform that can communicate with various networked components.

FIG. 11 depicts a cloud computing environment, consistent with an illustrative embodiment.

FIG. 12 depicts abstraction model layers, consistent with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to systems and methods for weather prediction using artificial intelligence modeling. Generally, the embodiments may be practiced in the fields of computers and computer networks. In one exemplary application, the embodiments may be practiced in the field of extreme weather forecasting for risk analysis.

In the subject disclosure that follows, embodiments propose a system and method that maps a complex historical climate data distribution into a known normal distribution that organizes the samples according to their probability. Such a schema allows for controlling the synthesis of samples according to how rare they are in the historical data. Considering that extreme climate events are rare, the proposed model can control the synthesis of weather data from an auxiliary variable that efficiently models how extreme the event is. In one aspect, the subject technology automatically learns parameters from the training data and may disregard a formal definition of what extreme means for the specific location under consideration, and automatically adapts for different climate conditions.

“Extremeness” as used herein may refer to an intensity of a weather type. An “extreme” weather event is defined as being farther from the norm than closer to the norm based on historical measurements. The threshold for “extremeness” may be defined by a user configuring a training model. For example, when evaluating precipitation, an extreme precipitation event would be considered high levels of rain well above average rainfall for a day, week, etc., which may cause for example, flooding. A hurricane is another example, of extreme precipitation. Droughts where the rainfall is well below the average rainfall is also considered an extreme event even though opposite flooding or hurricane type events. In some embodiments, an extreme event may be a rare spatial-temporal distribution of rainfall for a given trained location. Rarity may be related to a rare latent representation of rainfall patterns considering a historical weather pattern distribution. For wind type events, areas with a normally steady wind speed may be considered to experience extreme events when the wind increases heavily in gust type situations or there is virtually no wind for an extended period. This may be useful information when considering wind generation in an area or the possibility of fires in dry areas. While precipitation and wind are used as examples, it will be understood that other weather event patterns may be synthesized from the subject technology (which may include, for example, snow fall, heat, UV index, or any combination of measured weather characteristics). As will be appreciated, varying the threshold for “extremeness” may be useful since the extremeness of different weather event types may be considered more or less of a concern depending on the area and weather phenomena being studied.

Embodiments support controlling climate data synthesis according to how rare the climate event is in the training data. The technique maps a complex data distribution into a known probabilistic distribution that enables fine control of sampling and further coupled synthesis. The system may serve as middleware between extreme event predictors and output risk models and provide controllable stochastic synthesis of climate data for various scenarios. The main advantage of such a system compared to known art is that in some embodiments, the definition of “extreme” may be disregarded for the specific climate data and automatically adapts to different locations and environments.

In an exemplary embodiment, Variational Autoencoders (VAEs) may be used for synthesizing the data into predictive information for forecasting. In the embodiments disclosed, VAEs are an encoder-decoder generative model that may be configured to explicitly learn the training set distribution and enables stochastic synthesis by regularizing the latent space to a known distribution. Even if one can also trivially control VAEs synthesis using conditioning variables, such models also enable synthesis control from merely inspecting the latent space distribution to map where to sample to achieve synthesis with known characteristics.

In the subject disclosure, VAEs may be configured for generating weather field data synthesis towards more extreme weather event scenarios. A VAE model may be trained using a normal distribution for the latent space regularization. Then, assuming that extreme events in historical data are also rare, the synthesis may be controlled towards more extreme events by sampling from normal distribution tails, which should hold less common data samples. As will be appreciated, controlling the sampling space from a normal distribution implements an effective tool for controlling weather field data synthesis towards more extreme weather scenarios.

### Example Architecture

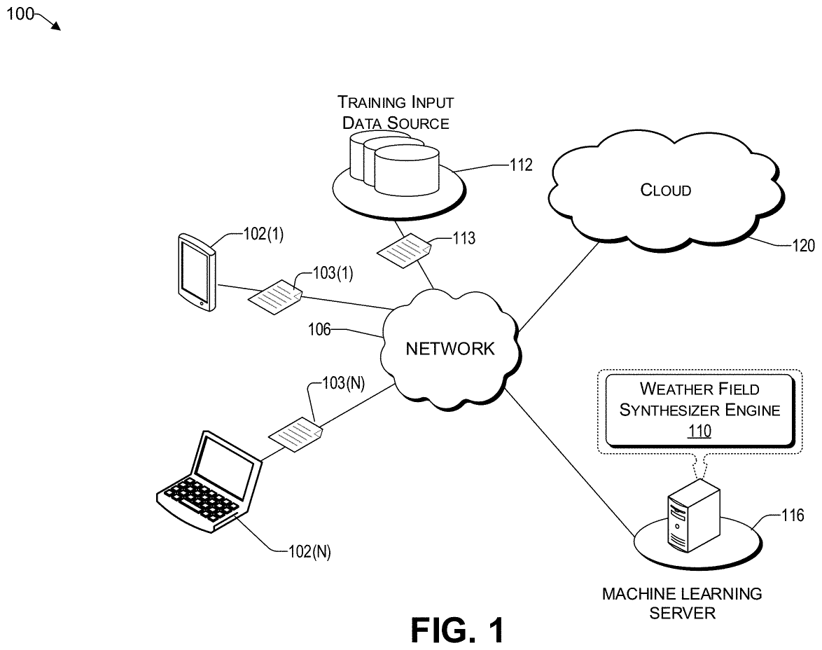

FIG. 1 illustrates an example architecture 100 for data synthesis. In an exemplary embodiment, the architecture 100 may be configured to synthesize weather field data for the prediction of extreme weather events. Architecture 100 includes a network 106 that allows various computing devices 102(1) to 102(N) to communicate with each other, as well as other elements that are connected to the network 106, such as update data source 112, a machine learning server 116, and the cloud 120.

The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet that provides various ancillary services, such as communication with various application stores, libraries, and the Internet. The network 106 allows a weather field synthesizer engine 110 (sometimes referred to simply as the “synthesizer engine 110”), which is a software program running on the machine learning server 116, to communicate with the data source 112, computing devices 102(1) to 102(N), and the cloud 120, to provide data processing of weather field data. The data source 112 may provide data from database sources including for example, fields sensors and stored weather archives. In an exemplary embodiment, artificial intelligence is one technique used for processing the data to build predictive models and in some embodiments, generate forecast probabilities of extreme weather events for an area. In one embodiment, the data processing is performed at least in part on the cloud 120.

For purposes of later discussion, several user devices appear in the drawing, to represent some examples of the computing devices that may be the source of data being analyzed depending on the task chosen. Aspects of the symbolic sequence data (e.g., 103(1) and 103(N)) may be communicated over the network 106 with the synthesizer engine 110 of the machine learning server 116. Today, user devices typically take the form of portable handsets, smart-phones, tablet computers, personal digital assistants (PDAs), and smart watches, although they may be implemented in other form factors, including consumer, and business electronic devices.

For example, a computing device (e.g., 102(N)) may send a query request 103(N) to the synthesizer engine 110 to generate data predictive of an extreme weather event.

While the data source 112 and the synthesizer engine 110 are illustrated by way of example to be on different platforms, it will be understood that in various embodiments, the update data source 112 and the machine learning server 116 may be combined. In other embodiments, these computing platforms may be implemented by virtual computing devices in the form of virtual machines or software containers that are hosted in a cloud 120, thereby providing an elastic architecture for processing and storage.

### Example Methodology

In the following methods, flowcharts are shown to help describe the processes involved. The flowcharts may be shown as divided into sections showing which entity types may perform certain steps in a process. However, it should be understood, that while some examples show human users performing some steps, some embodiments may instead perform those user shown steps by a machine (for example, a computer processor or other automated device or in some embodiments, a software application). As will be appreciated, certain aspects of the subject technology are necessarily rooted in computer technology (e.g., must be performed by a computing device) in order to overcome a problem specifically arising in the realm of computer related technology. For example, as will be seen below, some aspects use A.I. to model and train models which use weather field data to predict when more extreme weather phenomena may occur for a given location. Aspects of the subject technology may process tremendous amounts of weather data to identify the likelihood of weather events which may be considered damaging or disruptive for the area. The amount of data processed by the computer technology may exceed the ability of a group of humans to do so in a reasonable or practical time so that an extreme weather event in the near future may be predicted and steps taken to mitigate the negative results of such weather be performed. In addition, some steps may be described as performed by “the system” which may be interpreted in some instances as being perform by a machine or computing device implementing executable instructions.

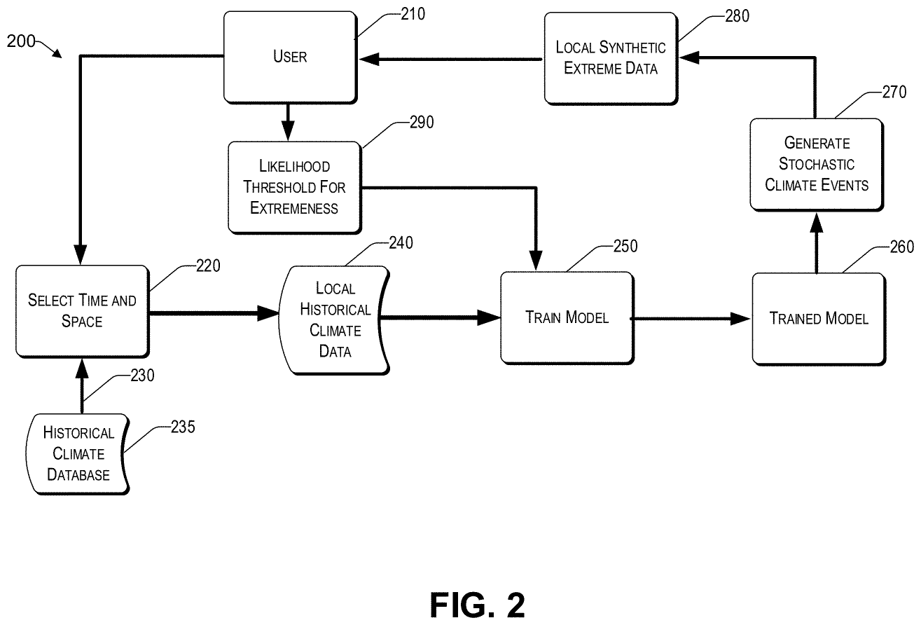

Referring now to FIG. 2, a method 200 (sometimes referred to simply as the “method 200”) for synthesizing extreme weather data is shown according to an exemplary embodiment. It should be understood that while a user 210 is shown in the method 200, the user implemented steps and the user 210 are disclosed for illustrative purposes only and are not considered part of the subject technology. In general, the method 200 may generate synthesized data for predicting the likelihood of an extreme weather event occurrence for a given location. “Likelihood” may refer to a probability value attached to a weather event/measurement (represented by a weather data point in the climate database), which may include the probability of the measurement being considered “extreme”. A predictive model is generated and trained to provide the probabilities of the weather even occurring. Considering historical weather data from a given location, the model is trained and afterwards the user may define an “extremeness” threshold value for synthesizing extreme weather data.

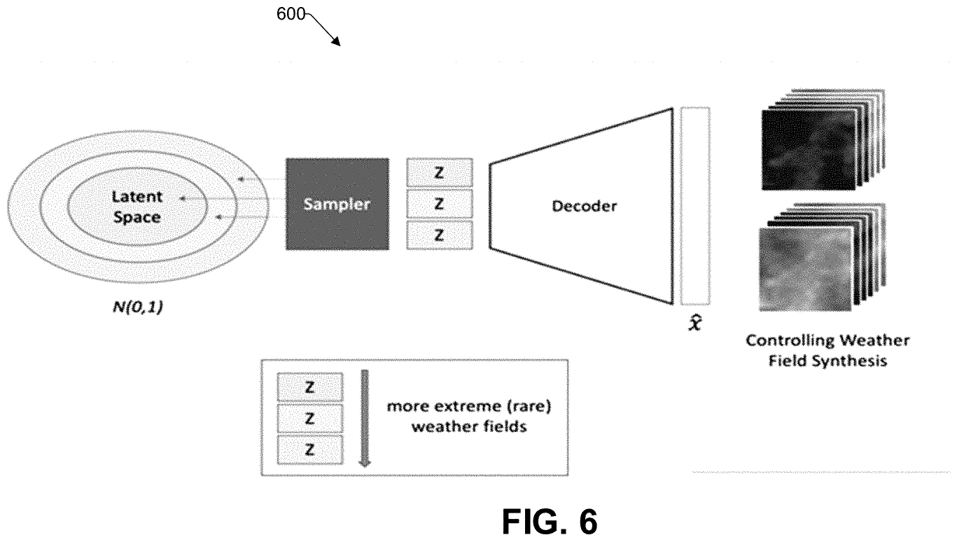

For example, the method 200 may include a user 210 selecting 220 a time and space for analyzing the probability of extreme weather events occurring. “Time and space” may refer to a date/time associated with a geographic location. Training data may be retrieved 230 from a historical climate database 235. Historical climate data 240 for the selected location may be used to train 250 a predictive model. Stochastic climate events may be generated 270 based on the data output of the trained model 260. An example of generating stochasticity from the data will be seen below, in FIGS. 6-8. Based on the stochastic event data, extreme data may be synthesized 280 for the location under study. In some embodiments, the user may define 290 a threshold value for the likelihood of a weather data point representing an extreme weather event.

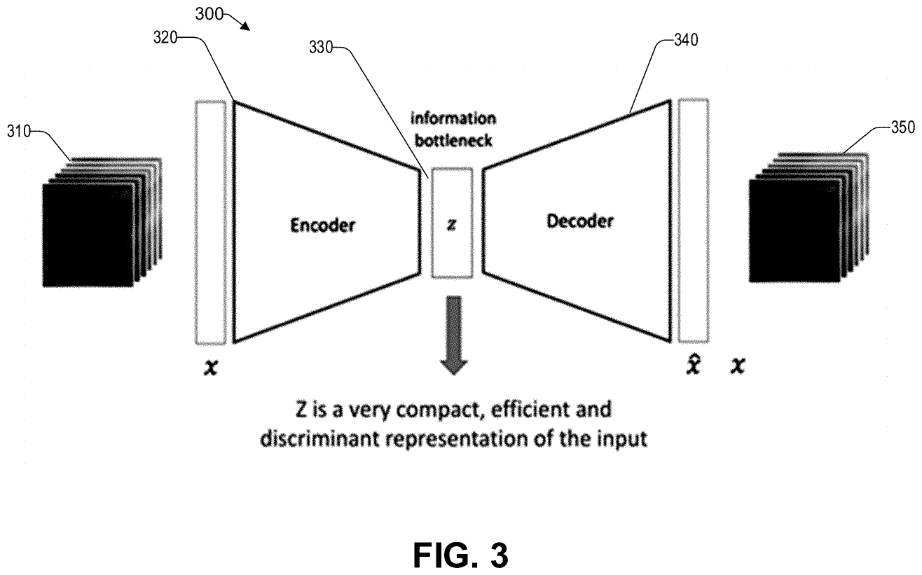

Referring now to FIG. 3, variational autoencoder (VAE) network 300 for training weather data is shown according to an exemplary embodiment. The VAE network 300 represents a module for finding an efficient data representation based on input weather data 310 for a location. The VAE 300 generally comprises an encoder 320 and a decoder 340. The encoder 320 may be responsible for creating an efficient data representation and the decoder 340 may be responsible for retrieving that representation and recreating the input 310 in the output 350. The training process computes the error and backpropagates it to update the neural network weights and finds the optimal configuration this way. After several iterations, the encoder 340 will be able to generate a compact data representation Z 330 that holds the relevant information from input climate data 310.

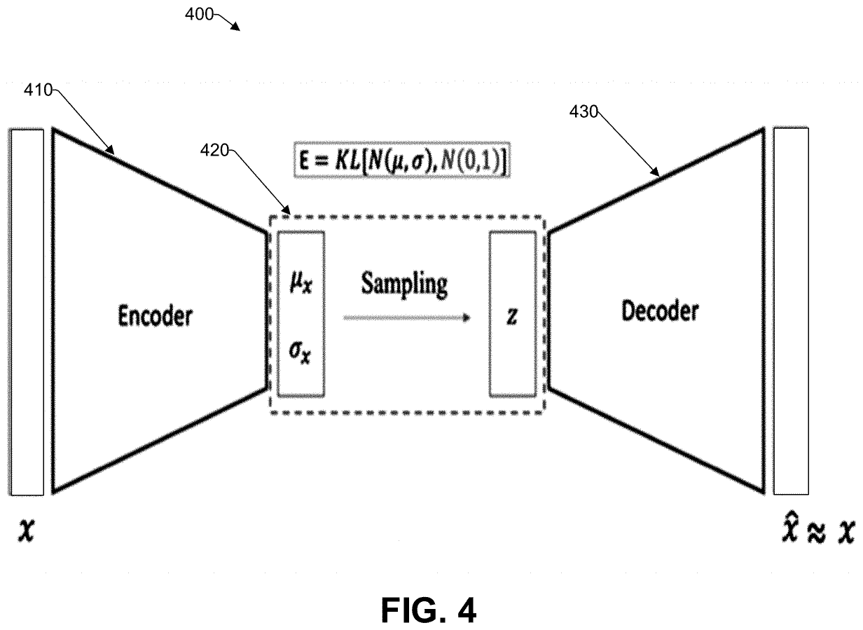

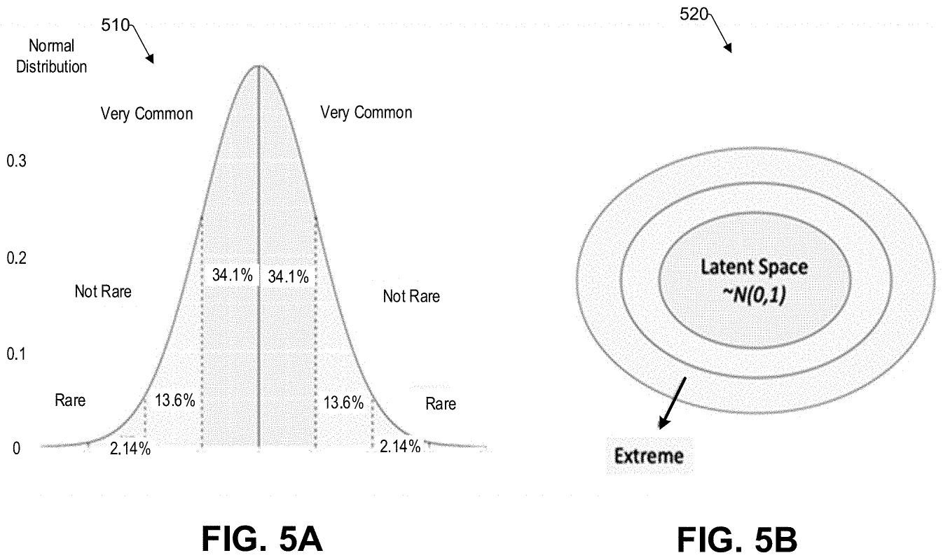

Referring now to FIG. 4, a schema architecture of a VAE network 400 for predicting extreme weather data is shown according to an exemplary embodiment. The VAE network 400 may include an encoder 410 that maps input data into dense layers representing means (μₓ) and standard deviations (σₓ), a sampling layer that samples from that distribution and a decoder 430 that maps latent data z into the output. In the VAE network 400, the decoder 430 may be configured to synthesize realistic data by sampling from Z distribution. To avoid inputting invalid data to the decoder 430, it will be appreciated that the use of a variational autoencoder 400 forces (regularizes) the latent space distribution 420 to follow a known, normal distribution, as depicted below in for example, FIGS. 5A and 5B. This process may be implemented using the Kullback-Leibler divergence metric together with the reconstruction error for training the optimal network weights.

With the trained network using the normal latent space distribution constraint, the schema created enables controlling the synthesis according to how extreme is the desired climate event synthesis. To perform that, the normal distribution may be evaluated and it may be assumed that extreme events are rarer than standard climate events for a given training data. That assumption makes the model organize the samples according to the distribution shown in FIGS. 5A and 5B, where samples close to the normal distribution average or mean are more common, or less extreme, and samples at the distribution tails are rare, or more extreme. In some embodiments, extreme events may be considered as events that are statistically three standard deviations (3 sigma) or father from the mean. In this way, controlling the “extremeness” of climate data synthesis using the trained decoder 430 of the subject technology resumes to controlling where to sample in the normal Z distribution. Inputting Z values located at the tails to the decoder 430, creates more extreme climate data samples, and inputting Z values located at the distribution bulk, creates standard, or more commonly observed climate data samples.

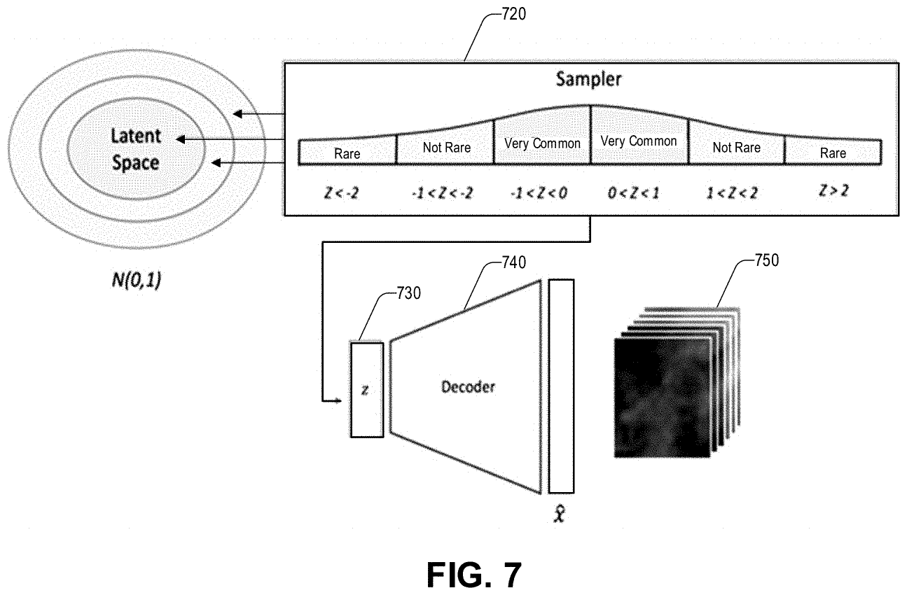

Referring now to FIG. 6, a proposed sampler schema 600 using the standard deviation to define loci in the normal distribution for selecting samples with different characteristics is shown according to an exemplary embodiment. In an exemplary embodiment, the synthesis may be controlled using a single variable for determining extremeness. With a trained decoder model that receives normal distribution data and decodes into weather field data, the subject technology leverages an inherent property of variational autoencoders training that cluster similar samples close together. The model may assume that regular weather samples will be allocated to the distribution bulk, while less common (including extreme) weather events will be allocated to the distribution tails. That configuration enables control of the synthesis by simply defining suitable loci in the distribution for sampling. With a rule that the more extreme an event is, the less likely it is to occur, the control schema for synthesis is shown according to one exemplary embodiment. Thresholds ti that define loci of the normal distribution to sample that are directly related to how the normal distribution probability. The higher ti, the less probable the synthesized sample would be, and supposedly, the more extreme. That simple procedure enables using the latent space mapping to control synthesis and create data coherent with more extreme climate scenarios. FIG. 7 shows an example of a sampler distribution result from example defined threshold values. Box 720 represents a sampler 720 provided to the latent space 730 of weather data samples. Samples 750 represent the output generated by the decoder 740 in the proposed schema. The darker a sample, the less rare the occurrence of the event the sample represents.

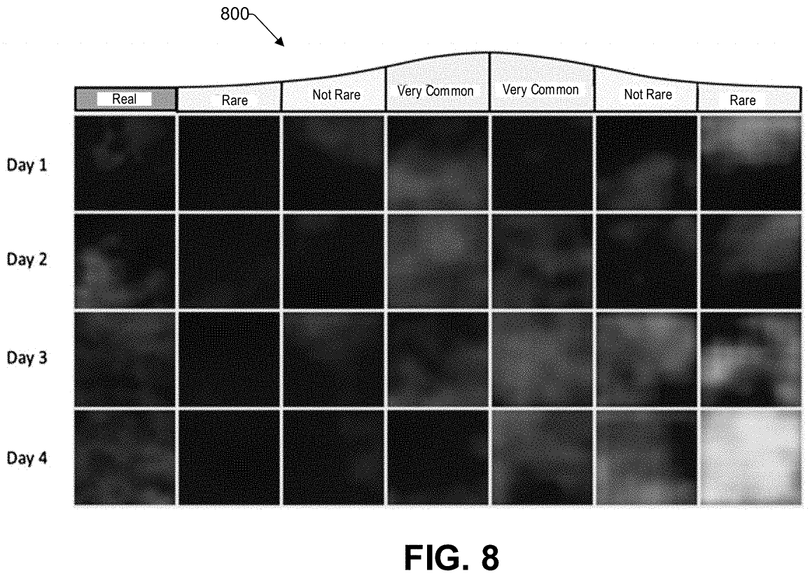

Referring now to FIG. 8, a quantile plot 800 of examples of synthesized samples considering different standard deviation scenarios, and real samples from the testing set as reference are shown according to an exemplary embodiment's results. Rows represent four different weather fields selected at random. For evaluating results, a quantile-quantile (QQ) plot, which is a probability plot used for comparing two probability distributions may be used. In QQ plots, the quantiles of the distributions are plotted against each other, and therefore a point on the plot corresponds to one of the quantiles of a given distribution plotted against the same quantile of another distribution. For the instant exemplary result, distribution is computed and shown. The samples were selected at random, and it is possible to observe that samples from the average standard deviation sampling are similar to those drawn from real data, as expected since they are more likely to happen. The samples synthesized using smaller standard deviation values depict weather fields with lower precipitation values, and the ones using larger standard deviation seem to show higher precipitation patterns.

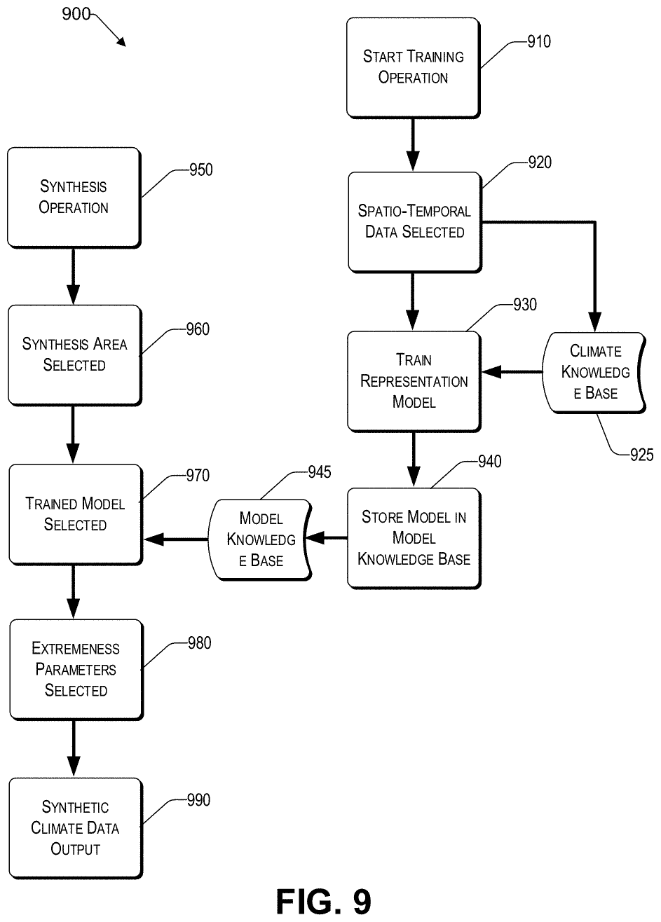

Referring now to FIG. 9, a method 900 of synthesizing weather data for the prediction of extreme weather events is shown according to an exemplary embodiment. The method 900 may be divided into two stages: a configuration phase and an operation phase.

In the configuration phase, the user may start 910 the model training operation. The system may receive 920 a target location and temporal window for training the model. The system may train 930 the model using for example, weather data associated with the selected target location. The weather data may be obtained from a climate knowledge database 925. The trained model may hold characteristics of the location climate data, including how probable extreme events are. In this way, the system automatically adapts to the climate observed in the location defined by the user and considering the time window defined by the user. The system may store 940 the trained model in the model database 945 together with contextual information, such as the location and time window used for training.

In the operation phase, the data synthesis operation may be started 950. A location for creating realistic climate data that resembles the ones observed in real data from the informed location may be selected/input 960. The system may select 970 a model trained in the location specified or that holds similar contextual information, if the location is not strictly available. The selected model may be retrieved for example, from the model database 945. The parameters for “extremeness” may be set 980 to control how extreme the climate events will be in the synthesized samples. The system may output 990 synthetic stochastic climate data samples, based on the parameters set for extremeness.

### Example Computer Platform

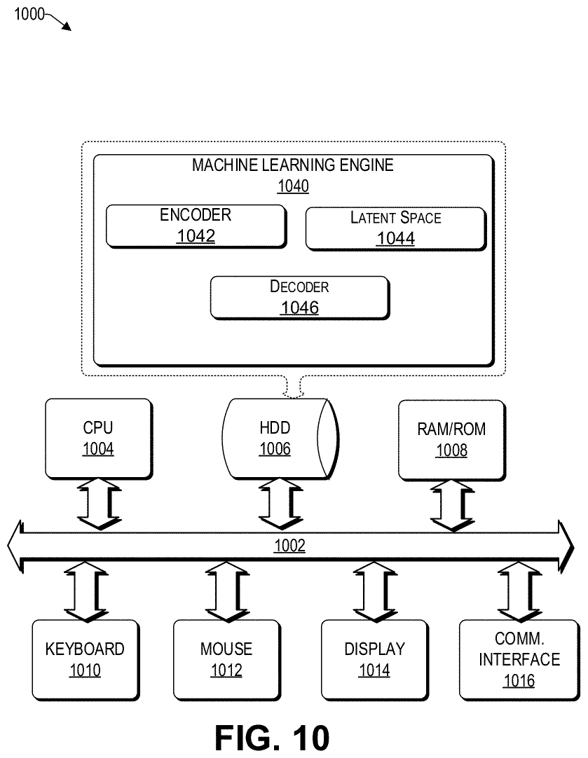

As discussed above, functions relating to interpretable modeling of extreme weather phenomena can be performed with the use of one or more computing devices connected for data communication via wireless or wired communication, as shown in FIG. 1. FIG. 10 is a functional block diagram illustration of a computer hardware platform that can communicate with various networked components, such as a training input data source, the cloud, etc. In particular, FIG. 10 illustrates a network or host computer platform 1000, as may be used to implement a server, such as the machine learning server 116 of FIG. 1.

The computer platform 1000 may include a central processing unit (CPU) 1004, a hard disk drive (HDD) 1006, random access memory (RAM) and/or read only memory (ROM) 1008, a keyboard 1010, a mouse 1012, a display 1014, and a communication interface 1016, which are connected to a system bus 1002.

In one embodiment, the HDD 1006, has capabilities that include storing a program that can execute various processes, such as the machine learning engine 1040, in a manner described herein. Generally, the machine learning engine 1040 may be configured to analyze computing devices for projected stability after a software upgrade under the embodiments described above. The machine learning engine 1040 may have various modules configured to perform different functions. In some embodiments, the machine learning engine 1040 may include sub-modules. For example, an encoder 1042, a latent space 1044, and a decoder 1046.

### Example Cloud Platform

As discussed above, functions relating to analyzing the impact of a software upgrade on a computing device, may include a cloud 120 (see FIG. 1). It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

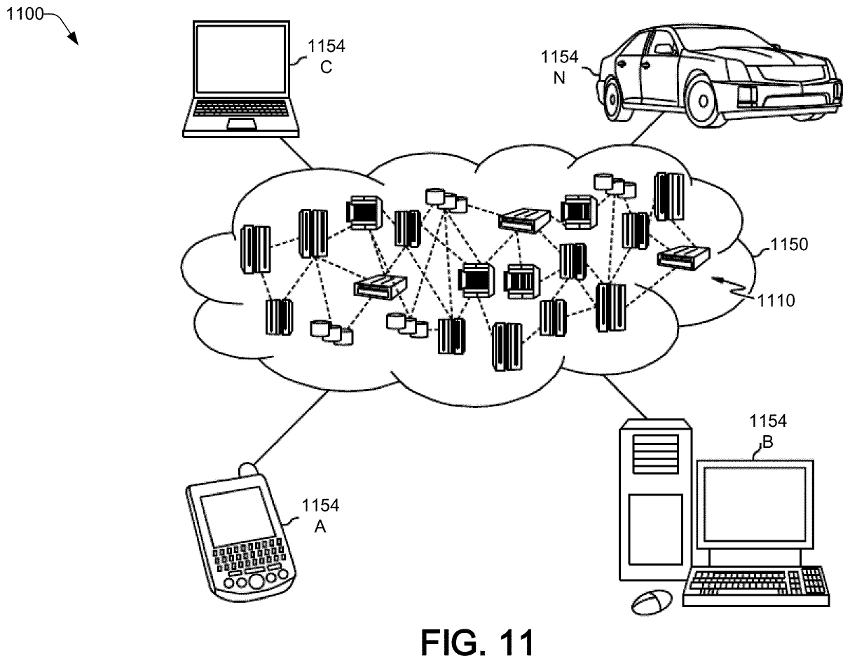

Referring now to FIG. 11, an illustrative cloud computing environment 1100 is depicted. As shown, cloud computing environment 1100 includes one or more cloud computing nodes 1110 with which local computing devices used by cloud consumers, such as, for example, personal digital assistant (PDA) or cellular telephone 1154A, desktop computer 1154B, laptop computer 1154C, and/or automobile computer system 1154N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices 1154A-N shown in FIG. 11 are intended to be illustrative only and that computing nodes 1110 and cloud computing environment 1150 can communicate with any type of computerized device over any type of network and/or network addressable connection (e.g., using a web browser).

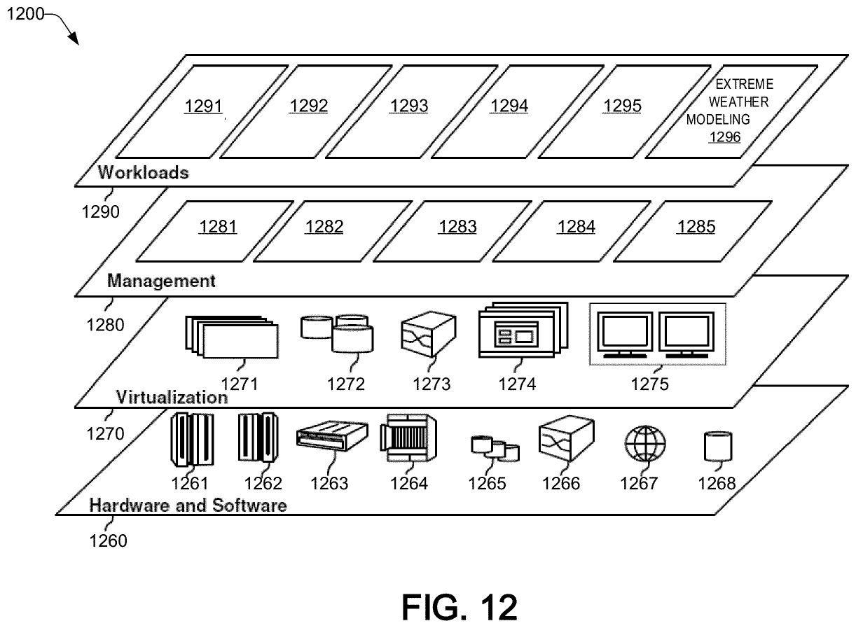

Referring now to FIG. 12, a set of functional abstraction layers provided by cloud computing environment 1150 (FIG. 11) is shown. It should be understood in advance that the components, layers, and functions shown in FIG. 12 are intended to be illustrative only and embodiments of the disclosure are not limited thereto. As depicted, the following layers and corresponding functions are provided:

Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfillment 1285 provide pre-arrangement for, and procurement of, cloud computing resources for which a future requirement is anticipated in accordance with an SLA.

Workloads layer 1290 provides examples of functionality for which the cloud computing environment may be utilized. Examples of workloads and functions which may be provided from this layer include: mapping and navigation 1291; software development and lifecycle management 1292; virtual classroom education delivery 1293; data analytics processing 1294; transaction processing 1295; and extreme weather modeling service 1296, as discussed herein.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer implemented method for generating predictive weather occurrences,
comprising:
generating, by a computer processor, a training model through artificial intelligence, wherein the training model is based on climate data processed by a variational autoencoder;
selecting a geographic location for climate study;
retrieving from a climate knowledge database, historical weather measurements associated with the selected geographic location;
processing the retrieved historical weather measurements using the training model;
receiving, by the training model, threshold parameters defining an extremeness of weather, wherein the extremeness is based on a weather intensity data point being farther from a distribution mean than closer to the distribution mean; and
generating synthetic weather data, for the selected location, wherein the synthetic data predicts weather events that satisfy the extremeness threshold parameters.

2. The method of claim 1, wherein the generated synthetic weather data is based on a stochastic distribution of the retrieved historical weather measurements.

3. The method of claim 2, wherein the weather events satisfying the extremeness threshold parameters include data on tails of the stochastic distribution of the retrieved historical weather measurements.

4. The method of claim 1, wherein the weather events satisfying the extremeness threshold parameters are based on a rarity of occurrence in the training model.

5. The method of claim 1, further comprising normalizing, by the training model, a distribution of the retrieved historical weather measurements.

6. The method of claim 5, wherein the normalization is performed according to a Kullback-Leibler divergence metric.

7. The method of claim 1, further comprising:
receiving a likelihood value for the threshold parameters, wherein the likelihood value represents a probability of a weather data point satisfying the extremeness threshold parameters;
distributing the processed retrieved historical weather measurements into a normalized distribution; and
identifying weather data points satisfying the extremeness threshold parameters based on the likelihood value.

8. A computer program product for generating predictive weather occurrences, the computer program product comprising:
one or more computer readable storage media, and program instructions collectively stored on the one or more computer readable storage media, the program instructions comprising:
generating, by a computer processor, a training model through artificial intelligence, wherein the training model is based on climate data processed by a variational autoencoder;
selecting a geographic location for a climate study;
retrieving from a climate knowledge database, historical weather measurements associated with the selected geographic location;
processing the retrieved historical weather measurements using the training model;
receiving, by the training model, threshold parameters defining an extremeness of weather, wherein the extremeness is based on a weather intensity data point being farther from a distribution mean than closer to the distribution mean; and
generating synthetic weather data, for the selected location, wherein the synthetic data predicts weather events that satisfy the extremeness threshold parameters.

9. The computer program product of claim 8, wherein the generated synthetic weather data is based on a stochastic distribution of the retrieved historical weather measurements.

10. The computer program product of claim 9, wherein the weather events that satisfy the extremeness threshold parameters include data on tails of the stochastic distribution of the retrieved historical weather measurements.

11. The computer program product of claim 8, wherein the weather events satisfying the extremeness threshold parameters are based on a rarity of occurrence in the training model.

12. The computer program product of claim 8, wherein the program instructions further comprise normalizing, by the training model, a distribution of the retrieved historical weather measurements.

13. The computer program product of claim 12, wherein the normalization is performed according to a Kullback-Leibler divergence metric.

14. The computer program product of claim 8, wherein the program instructions further comprise:
receiving a likelihood value for the threshold parameters, wherein the likelihood value represents a probability of a weather data point satisfying the extremeness threshold parameters;
distributing the processed retrieved historical weather measurements into a normalized distribution; and
identifying weather data points satisfying the extremeness threshold parameters based on the likelihood value.

15. A computer server for generating predictive weather occurrences, comprising:
a network connection;
one or more computer readable storage media;
a processor coupled to the network connection and coupled to the one or more computer readable storage media; and
a computer program product comprising program instructions collectively stored on the one or more computer readable storage media, the program instructions comprising:
generating by the computer processor, a training model through artificial intelligence, wherein the training model is based on climate data processed by a variational autoencoder;
selecting a geographic location for a climate study;
retrieving from a climate knowledge database, historical weather measurements associated with the selected geographic location;
processing the retrieved historical weather measurements using the training model;
receiving, by the training model, threshold parameters defining an extremeness of weather, wherein the extremeness is based on a weather intensity data point being farther from a distribution mean than closer to the distribution mean; and
generating synthetic weather data, for the selected location, wherein the synthetic data predicts weather events that satisfy the extremeness threshold parameters.

16. The computer server of claim 15, wherein the generated synthetic weather data is based on a stochastic distribution of the retrieved historical weather measurements.

17. The computer server of claim 15, wherein the weather events satisfying the extremeness threshold parameters include data on tails of the stochastic distribution of the retrieved historical weather measurements.

18. The computer server of claim 15, wherein the weather events satisfying the extremeness threshold parameters are based on a rarity of occurrence in the training model.

19. The computer server of claim 15, wherein the program instructions further comprise normalizing, by the training model, a distribution of the retrieved historical weather measurements.

20. The computer server of claim 15, wherein the program instructions further comprise:
receiving a likelihood value for the threshold parameters, wherein the likelihood value represents a probability of a weather data point satisfying the extremeness threshold parameters;
distributing the processed retrieved historical weather measurements into a normalized distribution; and
identifying weather data points satisfying the extremeness threshold parameters based on the likelihood value.
